(19) United States
(12) Patent Application Publication
(10) Pub. No.: US 2006/0000538 A1
(43) Pub. Date: Jan. 5, 2006

(54) Construction systems for modular design of furniture

(76) Inventors: Kevin J. Cassells, Broomall, PA (US); Phillip Li, Philadelphia, PA (US)

Correspondence Address: Robert B. Famiglio, Esquire;Famiglio & Associates, P.O. Box 1999., Media, PA, 19063, US

(21) Appl. No.: 10/882,857

(22) Filed: Jul. 1, 2004

(51) Int. Cl. B32B 31/00

(52) U.S. Cl. 156/60

(57) ABSTRACT

A method of modular construction for fabricating kitchen, bath or other countertops from modular pieces into a single laminated piece is disclosed. The method allows the inventorying of prefabricated modular countertop pieces such as that made from Corian® or other similar material. Using the method, a customer selecting a desired configuration of modular pieces can be provided a countertop, kitchen top or bathroom unit which is a singular piece, including lamination of a custom sink basin to be integrated into any selected countertop. The method disclosed allow for custom production using standardized or modular pieces, thereby reducing costs for construction while accelerating the delivery time to a customer.

### BACKGROUND OF THE INVENTION

1. Field of the Invention

The present invention provides an improved method for fabricating complete kitchen, bathroom or other countertop system modular components, providing an integrated seamless unit. The method includes inventorying of standard modular components and completion of the components to provide a seamless result, thereby providing the appearance of a custom built unitary countertop. The present invention relates to a method of constructing furniture and a system that employs repeatable elements that can be combined in a variety of ways at a customer's selection to provide different types of furniture that have the appearance of a custom countertop or cabinet system.

2. Description of the Prior Art

Kitchen and countertops are typically requested by customers to fit a particular desired installation. Whether in new construction or refabrication of existing facilities, customer's frequently desire custom fabrication so that they may select the configuration of the sink basins, cabinet location and countertops to fit an existing space designed by the customer or the customer's design professional.

Fabricating countertop materials such as with Corian® or Formica® has been known for some time and is frequently the subject of many products that are available for consumers on the market. There is a desire to reduce price and yet provide the custom configuration that a customer may require to fit particular dimensions for the location of the countertop and related furniture. Accordingly, modular construction, which is also used in the present art, requires seams, and connection techniques to adjoin modular components in a fashion which do not present a seamless construction technique. This is particularly true when sink basins are attached to a matching countertop when the design is not constructed from a single piece of material such as Corian®.

Existing modular type furniture on the market today are typically a single use design. Basic structural parts of such kits cannot be used for other purposes. Time, materials, costs and labor could be saved if the structural components of a modular kitchen or bathroom countertop system could be used while presenting an appearance of having a custom built one piece countertop without the appearance of seams or connectors to hold the modular pieces together. The result of the method disclosed is a pleasing appearance of a custom built countertop with a sink basin which appears to be molded as a singular unit with the countertop displaying no seams or connectors.

Therefore, it is the object of the present invention to provide a modular furniture construction system whose structural components may be used for several different configurations of countertops, without modification, while appearing to be a singular custom piece, saving time, materials, costs, and labor and having the appearance of a unit which is not constructed from modular pieces.

It is also the object of the present invention to provide a modular furniture construction system which uses modular components in which sink basins used in the system are prefabricated as part of an entire flange system such that the interface between the sink basin or bowl and the countertop surface in which the bowl is affixed is fabricated as a singular modular piece without seams between the bowl basin and the countertop providing for a homogenous prefabricated sink basin component.

### SUMMARY OF THE INVENTION

The enclosed method utilizes heat and/or epoxy welding to attach prefabricated modular units into a singular customer-selected configuration yielding a custom configured countertop for kitchen, bathroom, and other related uses. The invention utilizes an inventory of modular components which are prefabricated.

When selected by a customer for a given custom configuration, the components are heat welded into a singular unit in a fashion which does not reveal seams or connection interfaces between the components. The invention provides for a frame which supports a flange system which is integrated into sink basins used in the collection of modular components which comprise a typical kitchen or bathroom counter combination.

The invention also utilizes a framing method which allows the prefabricated modular units to be adequately supported by removing the stress imposed from the weight of the modular units from the seams connecting the basins to the flanges of the counter support. The invention provides for the application of prefabricated units which include a seamless unit containing one or more sink basins molded continuously and seamlessly to an entire flange system which drops into a countertop frame. By using seamless modular units which are themselves connected in a custom configuration using color coded epoxy or other color matching adhesive means to create a seamless countertop of a custom configuration.

### BRIEF DESCRIPTION OF THE DRAWINGS

FIG. 1 is a flowchart showing the steps carried out in the present invention.

FIG. 2 is a top plan view of a collection of modular components in a typical use of the components in carrying out the present invention.

FIG. 3 is a top plan view of a large sink basin module as used in the present invention.

FIG. 4 is a side plan view of a typical rim sink basin module as used in the present invention and illustrating the flange framework used in mounting sink basin modules.

FIG. 5 is a top plan view of a typical configuration of various system modules in a final configuration.

FIG. 6 is a profile view of a typical front rolled front edge finish piece used in the assembly of the modular components of the present invention.

### DETAILED DESCRIPTION OF THE PREFERRED EMBODIMENT

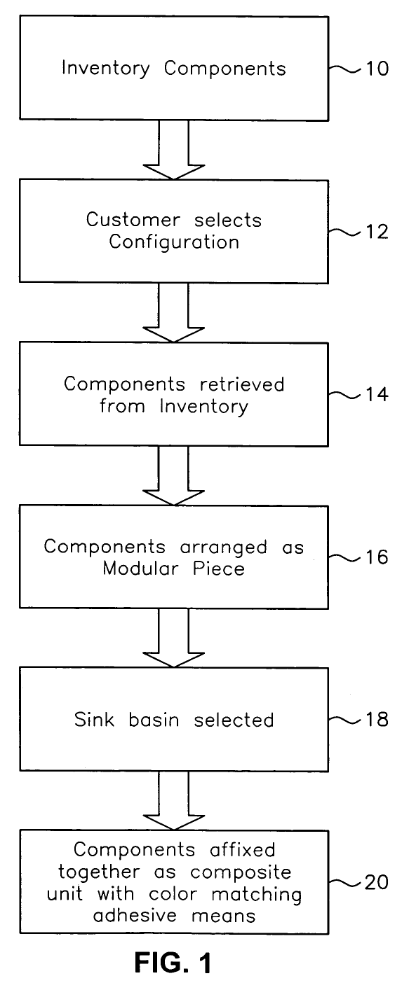

Turning now to the figures, the details of the method and apparatus will be described with particular reference to the figures, wherein like-numbers refer to like-parts or steps. FIG. 1 shows a block diagram of the steps in carrying out the method in the collection of the components. Certain standard components are inventoried as shown at 10. A typical customer will desire a custom configuration of modular bathroom or kitchen components and selects the configuration the customer prefers so that a custom configuration can be assembled, which appears as though it is a solid piece of material and not a constructed collection of modular components. Once a customer selects the configuration 12, the components necessary to configure the customer requirements are retrieved from inventory at 14. Once retrieved, components are arranged as modular pieces 16 by using such heat welding or color matched epoxy adhesives and other component assembly techniques such as to provide the appearance of a single laminar unit for installation at the customer's location.

In many installations a sink basin is selected 18 whereby it is desired that a basin selected by the customer be integrated into the surrounding flange of the modular units in a fashion such that there will be no obvious seam and the entire unit including the sink basin will appear to be a single piece of material. An interesting variation of the preferred embodiment occurs when a customer selects a sink basin at 18 which is a different color material than the material being used to assemble the major portion of the custom cabinetry or countertop. The sink basin and its surrounding flange can be selected with a color scheme providing contrast or affixed using color keyed epoxy between the basin and the flange.

In carrying out the invention, the selected sink basin is heat welded to the selected material for the countertop or kitchen top such as the final product appears to be a single piece of material without seams or attachment brackets being revealed. The type of product utilized to attach the modular components is an unsaturated polyester resin.

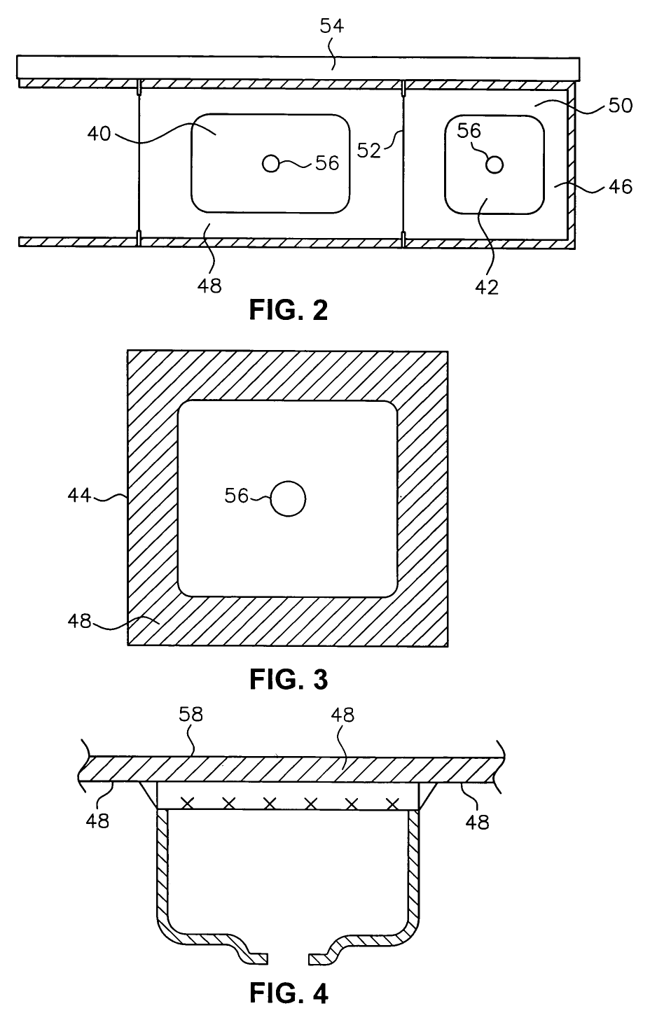

Turning to FIG. 2, an example of a countertop utilizing two separate sink modules is described. Large basin 40 and smaller basin 42 are integrated into their respective modules shown as large sink module 44 and smaller sink module 46. It can be appreciated by reviewing the plan view shown in FIG. 2 that the invention provides for a custom placement of either sink modules or other countertop modules which are seamed together as described above. By providing standard inventory parts of given size and shape, it is a simple matter of configuring the modules to produce the end countertop product desired by a customer.

In joining two pieces together, glue can be used but it is required that both edges of the modules being attached are matched together. There should be no gap between the pieces so that the seam is perfect when any glue applied is dried. In matching the surfaces of the modules to be applied, it is a simple matter of applying a mirror-cut to get an exact fit between two pieces that may not be precisely matched. In building a modular design countertop or kitchen top surface, back splash 54 can be attached to the final collection of modules glued together as described. In a typical sink basin as in large basin 40 or smaller basin 42 shown in FIG. 2, there are conventional sink drain holes shown at 56 which are used to match the standard hardware design for such drains in kitchens and bathrooms.

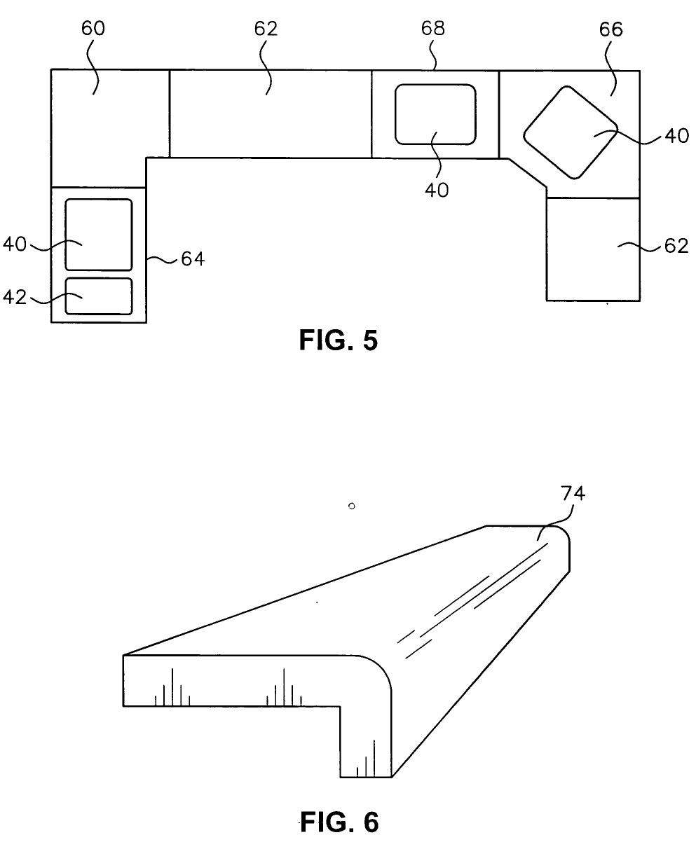

The invention is the use of the basin flanges to provide support for the sink basins shown in FIG. 2. The individual modules drop into a countertop such that the flanges of the modules are supported by a conventional counter supporting frame 72 as shown in FIG. 2. Since the flange of each modular unit is integrated as one piece with the sink basins, support of the weight of the basin is accomplished through the transmission of the port through the flange wherein the flange itself rests upon the underlying countertop support member shown for example as element 72 in the figures. FIG. 2 is a ghosted top view wherein the finished plan view is shown in FIG. 5 by way of an exemplary embodiment. Turning to FIG. 3, an expanded view of large sink module 46 is shown with an emphasis on the supporting flange at 48. FIG. 4 is a cutaway that shows the end view of the large sink module 44 illustrating the support available through the flange system at 48. As can be appreciated by the drawing, flange 48 frames the sink rim 58 shown in FIG. 4 to provide for the support necessary to allow the close engagement of the prefabricated sink module with the countertop around which the module is constructed. As can also be appreciated by one skilled in the art, it is possible to have a flush finish top edge of the large or small sink modules to provide for a flush countertop. The difference between a flush finished front edge and a rim top is a matter of design discretion, as may be selected by the customer, depending on preference.

Turning not to FIG. 5, a top view of a final configuration of a custom kitchen is demonstrated. The various components shown are prefabricated kits, which are installed, frequently by the homeowner or purchaser of the selected modules, into a configuration which suits the homeowner's needs. Corner section module 60 is used to connect other modules through the turn of a corner. In the preferred embodiment, the typical size of corner section module 60 is 29×29×26″ deep with a finished rolled 1½″ front edge, typically ¼″ thick. Module 60 typically is supplied with two pieces of 29″×4″ backsplash, which are used as backsplash and supports, as described above. Module 60 would also contain two pieces of prefabricated end caps of 26″×1.5″×½″, should the user of the module wish to have on the ends of module 60 terminating without connection to an additional module. One of the advantages of the present system is that standard capping strips or components with standard radius cuts can be supplied to be used with a variety of applications to finish the ends of countertops. For example, a standard 60″×3″×1½″ radius component can be cut in half to glue to the edge of a given countertop to finish the edge with a radius surface or, if desired, a square surface.

Four pieces of MDF material of approximately 29″×1″33 3″ are to be cut to fit the module and used as standard supporting structures. Each module includes a glue kit with instructions to arrange the modules into a custom configuration as suggested in FIG. 5. The MDF material is used as an underlayment support system similar to the support systems used in conventional countertop design using other types of materials which may be used in a countertop which is laminated with Formica® or other material.

Countertop module 62 is a main countertop surface which are normally used as connectors between sink basin modules or to complete a given area to working surface next to a basin module or other countertop module 62. Such modules can be rectangular or square as demonstrated in FIG. 5. Main countertop surfaces can be 72″×26″ with a rolled 1½″ integral edge ½″ thick, as with other modules. In a typical kit presentation from inventory, module 62 would include the main top surface as well as loose backsplash for use as seam supports, prefabricated end caps of 26″×1.5″ by ½″, and three strips of 72″×1″×3″ to be cut to fit the support structure required, usually at the perimeter of the top surfaces. As with all modules, a glue kit and instructions are included to provide the ability to attach each module.

Dual bowl sink module 64 provides for the double basin system as shown in FIG. 2. Smaller basin 42 and larger basin 40 are integrated into a seamless module 64 which can be fitted with the other modules as suggested in FIG. 5. Dual bowl sink module 64 provides two solid surface sinks, the larger of the two being 8″ deep and a 5″ deep basin. The typical kit from module 64 includes a loose backsplash, a finished rolled 1½″ front edge, and a glue kit, as with the other modules above.

Also shown in FIG. 5 is corner bowl sink module 66 and single bowl sink module 68, which demonstrates other standard configurations utilized in the present system. Single bowl sink module 68 features an 8″ deep basin with a loose backsplash, finished rolled 1½″ front edge and such glue components as necessary to mount the system. Corner bowl sink module 66 contains a similar 8″ deep basin, and loose backsplash pieces, glue kits and other rolled 1½″ front edge trim, as may be appropriate to provide the finishing effect desired.

The major advantage of the system presented is that a true solid surface for an integrated countertop can be presented after completely assembled for a significant reduction in cost than the solid surface material otherwise conventionally available. In the past, to provide the Corian®-like product required that the entire countertop be configured at the factory for one solid piece of such Corian® material or other similar fabricating material. Using the present invention, it is possible to provide a seamless integrated look and yet have the custom configuration that customers normally desire when they turn to conventional Formica® covered wooden top systems which do not allow for a seamless look when the modules are glued, attached or otherwise configured in an attempt to present a single surface.

As can also be appreciated, it is possible to design modular pieces in any shape or form to allow for installation of a modular countertop in a corner or in an L-shape island design by simply providing the pieces to drop into such design through the collection of the parts.

In carrying out the invention, it is important that the adhesive used to connect the seams of both modules utilizing an epoxy with a resin which is similar to the color of the top. By utilizing adhesive which has colorized resin, the seams are particularly invisible when the adhesive means has fully cured.

An epoxy-like adhesive is used with a conventional clear accelerator portion of the epoxy with the epoxy resin being the color of the top material that is ordered by the customer. Since the intent is for the top of the modules to be seamless and to be of a singular color or finish, it is normally not necessary to have more than one color resin for each installation.

The ratio of the mix used of the conventional epoxy is 98% resin to 2% accelerator. A typical single seam of a module can have adhesive applied in just several minutes, with the underside of each module being clamped together in a conventional fashion with typical wood shop clamps to hold two modules together while the epoxy adhesive hardens. It is important to note that in the adhesive process the two modules being attached to form an integrated configuration, similar to the example shown in FIG. 5, requires that the clamping action between two modules being joined is not over tight. It is useful to tighten any clamps used to hold two modules together during the drying process just so the adhesive mixture begins to rise out of the joint between two given modules. Over tightening the clamping action will force the mixture out of the seam, so it would be appreciated by those skilled in the art that a very small gap is desirable at the seam to allow the adhesive means to remain in contact with the edge of the two modules being affixed.

It is also sometimes desirable to sand the seam finish if any adhesive expands beyond the desired level so that the seam between the two modules essentially disappears to the naked eye.

FIG. 6 is a prospective view of a rolled accessory edge which can be used on any exposed front, side or rear edge of each individual module shown in FIG. 5. It can be appreciated that the rolled edge would necessarily be the same color component as the rest of the module and would be affixed along the front seam of each module to provide a continuous integrated modular appearance. The exemplary finishing or trim accessory finishing rolled edge 74 shown in FIG. 6 can be applied to any edge of the final structure comprised of the various modules as shown for example in FIG. 5. It can be appreciated that finishing rolled edge 74 can be affixed with the color coded adhesive to the edge of any of the different components shown in FIG. 5 to provide a finished edge on the rear or side of a given component if that rear or edge is exposed to view. To provide a limited number of inventoried modular components, it can be appreciated that it is desirable to have the supporting flange of each of the modules shown in FIG. 5 be equipped for mating on one edge on the side or rear to another modular component or to backsplash 54. In the event that the components are used in an “island” configuration, whereby the rear edge and side edges require a rolled finish rather than a straight flush match between the flange and the supporting counter, finishing edge 74 can be attached where desired to the edge as a standard component with its length matched to the standard size of the drop-in modular components described in the present invention. In such a fashion a user can apply accessory finishing edges to the front, side, or even the rear of the modules which are dropped into the countertop frames supporting a module in each instance. Therefore, a user can have a rolled finished overlap of a given edge surrounding a modular component dropped into the countertop as may be desired. The attachment between the edge 74 and each modular component as illustrated by example in FIG. 5 can be by color coded epoxy providing yet additional seamless finish giving the impression of an entire countertop component collection fabricated out of a single element of material.

One of the advantages of the present invention also includes the ability to have a variety of different modular components in the same size to allow for custom countertop at mass produced prices. For example, a customer may wish to have a large basin along with two small basins in a seamless countertop produced by dropping in the modules described above. Once the module laid out in the configuration selected by the customer, the adhesives are applied to provide for a seamless, finished product.

Similar to the exemplary finishing edge 74 shown in FIG. 6, it can be appreciated that other prefabricated edge surfaces can be shipped with a particular module or kit to allow the user to finish whatever edges of each module a user may desire. Other than rolled edges or a radius cut, standard pieces of edge finishing material as described above, pie-shaped rolled edges providing radius cuts for rounded or softened finished edges can be provided also. Such finishing edge pieces can be custom applied by the user to provide whatever finished edge is desired in a configuration such as that shown in FIG. 5.

What is claimed is:

1. A method of providing custom configured cabinetry from modular, preinventoried components comprising the steps of:
inventorying modular components preselected;
selecting the configuration desired by a given customer;
retrieving the desired components to assemble the customer selected configuration;
arranging the custom selected components in the configuration desired;
heat welding the components selected together such as to produce an end result of a seamless, unitary furniture or countertop design to appear as a single molded article of manufacture.

2. The method of claim 1, wherein further the customer selects a sink basin desired; and
said sink basin is heat welded to the selected countertop component to produce a single, heat welded seam.

3. The method of claim 2, wherein further the sink basin selected is a color which is different than the modular components selected.

4. A method of assembling a custom configured countertop from modular, preinventoried components comprising the steps of selecting one or more modular components from said inventory;
constructing a frame for each modular component utilizing at least one flange to frame each of said modular components; and
attaching the modular components together to provide a seamless, unitary countertop comprised of each of the modular units employed.

5. A method of creating an integrated countertop from modular, preselected components comprising the steps of:
selecting one or more modular components from said inventory;
constructing a frame for each modular component utilizing at least one flange to frame each said modular component;
fitting in each said modular component within the frame constructed by said flanges to support said modular component; and
attaching the modular components together to provide a seamless, unitary countertop by utilizing adhesive means to attach said seams between each said modular component.
